(19) United States
(12) Patent Application Publication
(10) Pub. No.: US 2006/0224810 A1
(43) Pub. Date: Oct. 5, 2006

(54) Motherboard with a switching function

(75) Inventors: Hung-Hsiang Chou, Taipei (TW); Chuan-Te Chang, Taipei (TW); Jiang-Wen Huang, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ASUSTeK Computer, Inc.

(21) Appl. No.: 11/385,179

(22) Filed: Mar. 20, 2006

(30) Foreign Application Priority Data
Mar. 30, 2005 (TW) 94110120

(51) Int. Cl. G06F 13/14

(52) U.S. Cl. 710/305

(57) ABSTRACT

A motherboard with a switching function has a substrate, a chipset, a control signal generator, an on-board device, an extension slot, and a switching circuit module. The switching circuit module disposed on the substrate has a first terminal connected to the chipset for receiving a input signal from the chipset, a second terminal for receiving a control signal from the control signal generator, a first output circuit connected to the first on-board device, and a second output circuit connected to the first extension slot. The control signal determines a turned on state of the first switch output circuit and the second output circuit.

### RELATED APPLICATIONS

The present application is based on, and claims priority from, Taiwan Application Serial Number 94110120, filed Mar. 30, 2005, the disclosure of which is hereby incorporated by reference herein in its entirety.

### BACKGROUND

1. Field of Invention

The present invention relates to a motherboard with a switching function. More particularly, the present invention relates to a motherboard with a switching function on a bus interface.

2. Description of Related Art

In computer system architecture nowadays, various interface specifications are provided for different kinds of applications, such as accelerated graphics port (AGP) interface for graphics cards, serial AT attachment (SATA) interface for hard disk drives and peripheral controller interface (PCI) commonly used for peripheral devices. All peripheral devices share a bandwidth of a single PCI host channel so that a computer system may slow down if huge amounts of data are transferred.

With growing improvement in computer device technology, the tendency is towards a broad bandwidth and a high transfer speed for a computer system; for example, SATA devices or gigabit LAN devices with high transfer speed are applied. Therefore, PCI Express interface specification was developed.

PCI Express interface features peer-to-peer and series transfer technology in contrast to the parallel and multi-drop technology of a conventional PCI interface. Each PCI Express bus includes a single lane, which is extendible, and not only avoids interference between data transferred for separate data but also provides a broad bandwidth on a single lane, known as PCI Express x1.

In chipsets provided nowadays, for example, a chipset supporting four or six PCI Express x1 devices is controlled by signals. Each set of signal is used for a specific function performed either through an on-board device such as network devices or storage devices, or through a PCI Express x1 slot in which users put an add-in card according to specific requirements.

Most chipsets do not support more PCI Express x1 devices than those mentioned above so that a trade-off must be made between on-board devices and extension slots on a motherboard for a restricted number of devices, according to the design of the motherboard. Users are thus restricted to use functions provided by on-board devices, or, conversely, more extension slots and fewer on-board devices are installed.

### SUMMARY

It is therefore an objective of the present invention to provide a motherboard with a switching function for users to employ selectively functions provided by an on-board device and an extension slot.

It is another objective of the present invention to provide a motherboard with a switching function for selectively employing several extension slots.

In accordance with the foregoing and other objectives of the present invention, a motherboard with a switching function is provided. A motherboard with a switching function includes a substrate, a chipset, a control signal generator, an on-board device, an extension slot and a switching circuit module.

The chipset is disposed on the substrate and the control signal generator is adapted for generating a control signal. The on-board device and the extension slot are both installed on the substrate as well and data therefrom are transmitted through a bus such as a PCI Express bus. The switching circuit module is disposed on the substrate, having a first output circuit, a second output circuit, a first terminal connected to the chipset, and a second terminal connected to the control signal generator for receiving a control signal.

In a preferred embodiment, the first output circuit includes a first transistor and a second transistor. The first transistor includes a first input contact connected to the first terminal for receiving an input signal, a first control terminal connected to the control signal generator for receiving the control signal and a first output contact connected to the first on-board device.

The second transistor includes a second input contact connected to the first terminal, a second control terminal connected to the first control terminal through an inverter, and a second output contact connected to the extension slot.

When the control signal is high-level, the first transistor is turned on so that the input signal enters the first input contact and the first on-board device works. When the control signal is low-level, the second transistor is turned on due to the inverter so that the input signal enters the second input contact and a device in the extension slot works. A type of the control signal level can be determined by a software or a firmware such as BIOS.

In conclusion, the invention allows switching between functions provided by an on-board device and a device in an extension slot according to need so that manufacturers are left much space for designing a motherboard. In turn, more functions are provided on-board, and users may use an add-in card to add a desired function through switching by a software and are not limited to the on-board function.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings, where:

FIG. 1 is a schematic diagram of disposition of devices in accordance with a preferred embodiment of the present invention; and

FIG. 2 is a circuit diagram of a switching circuit module in accordance with a preferred embodiment of the present invention.

### DESCRIPTION OF THE PREFERRED EMBODIMENTS

The present invention discloses a motherboard with a switching function. Selective switching between an extension slot and an on-board device on a bus is allowed according to demands. The present invention achieves the purpose stated above through a circuit providing a rapid switching function to match a high signal speed such as a PCI Express signal.

Reference will now be made in detail to the present preferred embodiments of the invention, examples of which are illustrated in the accompanying drawings. Wherever possible, the same reference numbers are used in the drawings and the description to refer to the same or like parts.

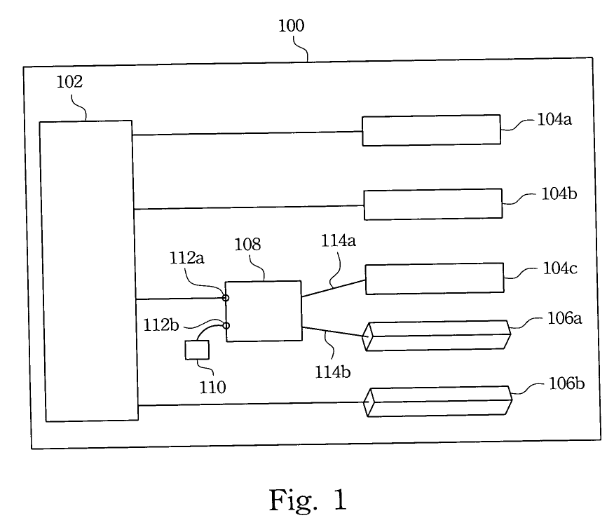

FIG. 1 is a schematic diagram of disposition of devices in accordance with a preferred embodiment of the present invention. The figure shows that a motherboard includes a substrate 100, a chipset 102, a control signal generator 110, a first on-board device 104c, a first extension slot 106a and a switching circuit module 108.

The chipset 102 for delivering an input signal to the switching circuit module 108 is disposed on the substrate 100 and the control signal generator 110 is for generating a control signal. The first on-board device 104c and the first extension slot 106a are installed on the substrate 100 and data thereof are transmitted through a bus, such as a PCI Express bus.

The switching circuit module 108 disposed on the substrate 100 includes a first output circuit 114a, a second output circuit 114b, a first terminal 112a connected to the chipset 102 for receiving an input signal from the chipset 102, and a second terminal 112b connected to the control signal generator 110 for receiving the control signal. The state of the first output circuit 114a and the second output circuit 114b is determined by the control signal. The first on-board device 104c is electrically connected to the first output circuit 114a and the first extension slot 106a is electrically connected to the second output circuit 114b.

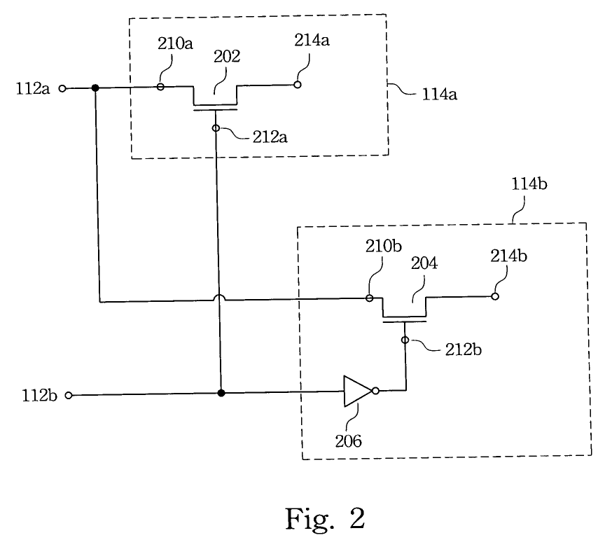

FIG. 2 is a circuit diagram of a switching circuit module in accordance with a preferred embodiment of the present invention. In the embodiment, the first output circuit 114a includes a first transistor 202 and the second output circuit 114b includes a second transistor 204. The first transistor 202 is turned on when the control signal is high-level and the second transistor 204 is turned on when the control signal is low-level. Transistors may be JFET, MOSFET or CMOSFET.

The first transistor 202 includes a first input contact 210a connected to the first terminal 112a for receiving the input signal, a first control terminal 212a connected to the control signal generator 110 for receiving the control signal and a first output contact 214a connected to the first on-board device 104c.

The second transistor 204 includes a second input contact 210b connected to the first terminal 112a, a second control terminal 212b connected to the control signal generator 110 through an inverter 206 and a second output contact 214b connected to the first extension slot 106a. The first transistor 202 is turned on when the control signal is high-level so that the input signal enters the first input contact 210a and outputs from the first output contact 214a. In contrast, the second transistor 204 is turned on when the control signal is low-level, so that the input signal enters the second input contact 210b and outputs from the second output contact 214b.

In the embodiment, MOS transistors are used. For both the first transistor 202 and the second transistor 204, gates are chosen to be control terminals 212a and 212b, drains are chosen to be input contacts 210a and 210b, and sources are chosen to be output contacts 214a and 214b.

The motherboard includes a chipset 102 supporting four PCI Express interface devices, a first extension slot 106a, a second extension slot 106b, a switching circuit module 108, a third on-board device 104a, a second on-board device 104b, and a first on-board device 104c. Extension slots and the above on-board devices are preinstalled on the motherboard and are used on the PCI Express bus.

The third on-board device 104a, the second on-board device 104b, the second extension slot 106b, and the first terminal 112a of the switching circuit module 108 are all electrically connected to the chipset 102. The first output circuit 114a is connected to the first on-board device 104c and the second output circuit 114b is connected to the first extension slot 106a.

Add-in cards (not shown), for example, video cards or audio cards, are installed in the first extension slot 106a and the second extension slot 106b. The on-board devices 104a, 104b and 104c may be graphics chips, audio chips, network chips, or other device providing a specific function on the motherboard.

During operation of the motherboard system, the total number of the on-board devices and the devices in the extension slots working simultaneously is only four due to a support limitation of the chipset 102.

When the control signal generator 110 generates a high-level control signal, for example, employing a software program or a firmware like BIOS to control a type of the control signal level, the first control terminal 212a of the first transistor 202 receives the high-level control signal and the first transistor 202 turns on. On the other hand, the high-level control signal enters the second control terminal 212b of the second transistor 204 as a low-level signal due to the inverter 206 so that the second transistor 204 is off.

Because the first transistor 202 is turned on, the input signal is transmitted through the first output contact 214a and the first output circuit 114a to the first on-board device 104c. In this way, the first on-board device 104c works and the device in the first extension slot 106a does not work.

When a low-level control signal is generated, the second control terminal 212b of the second transistor 204 receives the control signal rendered high-level due to inversion by the inverter 206 and the second transistor 204 turns on. On the other hand, the control signal enters the first control terminal 212a of the first transistor 202 as a low-level signal, so that the first transistor 202 is off.

Because the second transistor 204 is turned on, the input signal from the chipset 102 is transmitted through the second output contact 214b and the second output circuit 114b to the first extension slot 106a. In this way, the device in the first extension slot 106a works and the first on-board device 104c does not work.

Although the present invention has been described in considerable detail with reference to certain preferred embodiments thereof, other embodiments are possible. For example, the total number of devices supported by the chipset depends upon design of the chipset and the first input contact, and the second input contact may connect to an on-board device and an extension slot, or both extension slots. The invention does not limit the combination of devices to those described in the embodiment.

Such modifications should be considered part of the invention. Therefore, the spirit and scope of the appended claims should not be limited to the description of the preferred embodiments contained herein.

It can be seen from the aforementioned preferred embodiment of the present invention that the present invention has the following advantage. The invention provides an ability to employ selectively either an on-board device or an extension slot through a switching circuit module. Manufacturers are not only able to provide motherboards with more features, and consequently additional values, but users are also not limited to on-board functions provided by the motherboard. Selective application between a function provided by manufactures and an extension function demanded by users is achieved. Further, the way of switching through a software or a firmware is quite convenient and fast.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A motherboard with a switching function, comprising:
a substrate;
a chipset disposed on said substrate;
a control signal generator for generating a control signal;
a switching circuit module disposed on said substrate having a first output circuit, a second output circuit, a first terminal connected to said chipset, and a second terminal connected to said control signal generator, wherein said control signal determines a turned on state of said first output circuit and said second output circuit;
an on-board device disposed on said substrate and connected to said first output circuit; and
an extension slot disposed on said substrate and connected to said second output circuit.

2. The motherboard of claim 1, wherein said first output circuit comprises a first transistor, and said second output circuit comprises a second transistor and an inverter, wherein when said control signal is high-level, said first transistor is turned on and when said control signal is low-level, said second transistor is turned on due to the inverter.

3. The motherboard of claim 2, wherein said first transistor has a first input contact connected to said first terminal for receiving an input signal, a first control terminal connected to said control signal generator for receiving said control signal, and a first output contact connected to said on-board device and said second transistor has a second input contact connected to said first terminal, a second control terminal connected to said control signal generator through said inverter, and a second output contact connected to said extension slot, wherein when said control signal is high-level, said first transistor is turned on and said input signal enters said first input contact, and when said control signal is low-level and becomes high-level through said inverter, said second transistor is turned on and said input signal enters said second input contact.

4. The motherboard of claim 3, wherein said first control terminal and said second control terminal are gates.

5. The motherboard of claim 2, wherein said first transistor and/or said second transistor is a MOSFET.

6. The motherboard of claim 2, wherein said first transistor and/or said second transistor is a JFET.

7. The motherboard of claim 1, wherein said control signal generator is a software.

8. The motherboard of claim 1, wherein said control signal generator is a firmware.

9. A motherboard with a switching function, comprising:
a substrate;
a chipset disposed on said substrate;
a control signal generator for generating a control signal;
a switching circuit module disposed on said substrate having a first output circuit, a second output circuit, a first terminal connected to said chipset, and a second terminal connected to said control signal generator, wherein said control signal determines a turned on state of said first output circuit and said second output circuit;
a first extension slot disposed on said substrate and connected to said first output circuit; and
a second extension slot disposed on said substrate and connected to said second output circuit.

10. The motherboard of claim 9, wherein said first output circuit comprises a first transistor and said second output circuit comprises a second transistor and an inverter, wherein when said control signal is high-level, said first transistor is turned on, and when said control signal is low-level, said second transistor is turned on due to the inverter.

11. The motherboard of claim 10, wherein said first transistor has a first input contact connected to said first terminal for receiving an input signal, a first control terminal connected to said control signal generator for receiving said control signal, and a first output contact connected to said first extension slot, and said second transistor has a second input contact connected to said first terminal, a second control terminal connected to said control signal generator through said inverter, and a second output contact connected to said second extension slot, and wherein when said control signal is high-level, said first transistor is turned on and said input signal enters said first input contact, and when said control signal is low-level and becomes high-level through said inverter, said second transistor is turned on and said input signal enters said second input contact.

12. The motherboard of claim 10, wherein said first transistor and/or said second transistor is a JFET or a MOSFET.

13. The motherboard of claim 9, wherein said control signal generator is a software.

14. The motherboard of claim 9, wherein said control signal generator is a firmware.
